(19) United States
(12) Patent Application Publication
(10) Pub. No.: US 2014/0255806 A1
(43) Pub. Date: Sep. 11, 2014

(54) METHANE-BASED POWER GENERATION WITH ZERO-CARBON EMISSIONS

(71) Applicants: UNIVERSITY OF SOUTHERN CALIFORNIA, Los Angeles, CA (US); CALIFORNIA INSTITUTE OF TECHNOLOGY, Pasadena, CA (US)

(72) Inventors: Gani B. Ganapathi, La Crescent, CA (US); Sri R. Narayan, Arcadia, CA (US); Surya G. Prakash, Hacienda Heights, CA (US)

(73) Assignees: UNIVERSITY OF SOUTHERN CALIFORNIA, Los Angeles, CA (US); CALIFORNIA INSTITUTE OF TECHNOLOGY, Pasadena, CA (US)

(21) Appl. No.: 14/205,028

(22) Filed: Mar. 11, 2014

Related U.S. Application Data
(60) Provisional application No. 61/776,378, filed on Mar. 11, 2013.

(51) Int. Cl. H01M 8/06; H01M 8/10

(52) U.S. Cl. CPC H01M 8/0618; H01M 8/10; H01M 8/0625; H01M 2220/10
USPC 429/415; 429/425

(57) ABSTRACT

The present invention provides a method of converting a hydrocarbon into H₂ and a carbon material comprising substantially no CO₂, whereby the H₂ is used by a fuel cell to generate electrical energy and the carbon material is collected. The method includes heating a hydrocarbon and a catalyst in a reactor to form H₂ and a carbon material comprising substantially no CO₂. A fuel cell is operated to generate electrical energy and heat using the H₂ formed in the reactor. The step of heating is repeated using the heat generated in the fuel cell. The present invention also provides a system for converting a hydrocarbon into H₂ and a carbon material comprising substantially no CO₂, whereby the H₂ is used by a fuel cell to generate electrical energy and the carbon material is collected.

### CROSS-REFERENCES TO RELATED APPLICATIONS

This Application claims the benefit of priority to U.S. Provisional Application No. 61/776,378, filed Mar. 11, 2013, incorporated in its entirety herein for all purposes.

### STATEMENT AS TO RIGHTS TO INVENTIONS MADE UNDER FEDERALLY SPONSORED RESEARCH OR DEVELOPMENT

The invention described herein was made in the performance of work under a NASA contract, and is subject to the provisions of Public Law 96-517 (35 U.S.C. §202) in which the Contractor has elected to retain title.

### BACKGROUND OF THE INVENTION

One of the major shortcomings of conventional power generation from hydrocarbons is the resulting emission of carbon dioxide, CO₂. For instance, in the case of methane, CH₄, approximately ½ ton of carbon dioxide is emitted per megawatt-hour of electrical energy. Although attempts have been made to sequester the carbon dioxide, known methods of carbon capture result in significant efficiency losses. Conventional methane-based power plants with combined cycle enhancement generally operate at approximately 60% plant efficiency. Known methods of carbon capture can expend as much as 25% of the energy produced, thus resulting in a net plant efficiency of around 37%. Moreover, carbon dioxide has virtually no industrial utility and thus storage of carbon dioxide is generally required upon sequestration. Long-term storage of pressurized carbon dioxide is highly expensive and presents the danger of catastrophic release.

Hydrogen fuel cells are a promising alternative to hydrocarbon-based power generation. Such fuel cells are capable of producing electricity with little or no carbon dioxide emissions, and recent advances in fuel cell research have led to hydrogen fuel cells with the potential for large-scale energy production applications. For instance, solid oxide fuel cells have been developed that are highly efficiency (e.g., 60-70%) and relatively inexpensive. These fuel cells utilize an electrolyte consisting of a ceramic material such as yttria-stabilized zirconia (YSZ). Oxygen gas, O₂, is introduced at a cathode where it is ionized to form O²⁻ ions that migrate through the ceramic electrolyte to react with hydrogen gas, H₂, at an anode. This reaction results in electrons that pass from the anode through an external circuit to the cathode where they are made available for the ionization of oxygen gas. The movement of electrons results in direct current electricity and, as with other types of hydrogen fuel cells, water, H₂O, is the byproduct of the chemical reaction.

Although hydrogen fuel cells are capable of producing electricity without carbon dioxide emissions, their feasibility for large scale energy production is limited by the unavailability of hydrogen which exists on Earth primarily in a bound form in chemical compounds such as hydrocarbons and water. In solid oxide fuel cells, one solution has been to incorporate a reformer that “cracks” light hydrocarbon molecules to generate the hydrogen fuel. However, current methods for reforming hydrocarbons generate carbon dioxide as a byproduct, thereby negating a primary advantage of hydrogen-based energy production.

Early work unrelated to power production investigated the use of hydrocarbons to grow carbon material on iron-based catalysts. For instance, Tibbetts demonstrated that exposing iron-based particles at temperatures near 1000° C. in a hydrocarbon gas resulted in the growth of graphitized carbon fibers from the particles (G. G. Tibbetts, Carbon, 1989, 27(5), 745-747). Although such work confirmed that carbon could be captured from a hydrocarbon to form carbon fiber, no mechanism has been developed for utilizing the hydrogen generated by such a reaction. Moreover, the high temperatures required for the reaction to occur suggest that such a method for generating hydrogen would be highly inefficient.

What is needed are a method and system for efficiently converting a hydrocarbon into hydrogen and a carbon material such that the carbon material includes substantially no carbon dioxide, while the hydrogen can be used by a fuel cell to generate electrical energy.

### SUMMARY OF THE INVENTION

In one embodiment, the present invention provides a method of converting a hydrocarbon into H₂ and a carbon material comprising substantially no CO₂, whereby the H₂ is used by a fuel cell to generate electrical energy and the carbon material is collected. The method includes heating a hydrocarbon and a catalyst in a reactor to form H₂ and a carbon material comprising substantially no CO₂. A fuel cell is operated to generate electrical energy and heat using the H₂ formed in the reactor. The step of heating is repeated using the heat generated in the fuel cell.

In another embodiment, the present invention provides a system for converting a hydrocarbon into H₂ and a carbon material comprising substantially no CO₂, whereby the H₂ is used by a fuel cell to generate electrical energy and the carbon material is collected. The system includes a reactor configured to heat a hydrocarbon and a catalyst to form H₂ and a carbon material comprising substantially no CO₂. The system further includes a fuel cell configured to generate electrical energy and heat using the H₂ formed by the reactor, and to transfer the generated heat to the reactor.

### BRIEF DESCRIPTION OF THE DRAWINGS

FIG. 1 shows a system for converting a hydrocarbon into H₂ and a carbon material, the H₂ being usable by a fuel cell to generate electrical energy, and the carbon material comprising substantially no CO₂.

### DETAILED DESCRIPTION OF THE INVENTION

### I. General

The present invention provides methods and systems for converting a hydrocarbon into H₂ and a carbon material at high temperatures, the carbon material comprising substantially no CO₂, the H₂ being usable by a fuel cell to generate electrical energy and heat, and the heat being usable by the reactor to further generate H₂ and carbon material. A hydrocarbon and a catalyst can be heated in a reactor to form H₂ and a carbon material that comprises substantially no CO₂. The carbon component of the hydrocarbon can instead form high-value types of solid carbon such as carbon fibers, carbon black, carbon nanotubes, buckyballs, graphite flakes, graphene, mesoporous microbeads, and the like. The H₂ can be supplied to the fuel cell for generation of electricity. The fuel cell can also generate heat, a portion of which can then be transferred back to the reactor and used to further convert hydrocarbon into H₂ and carbon material.

As a non-limiting illustration, a hydrocarbon such as methane can be introduced into a catalytic reactor along with a precursor such as iron nitrate, Fe(NO₃)₃, introduced as a fine mist of aqueous solution. The mixture can be initially heated to a temperature of about 650° C. using, for instance, an external heating source such as a methane combustion reaction or a renewable source such as a solar concentrator. As a result of the heating, the iron nitrate can decompose to form Fe nanoparticles that provide nucleation sites for conversion of the methane into H₂ and carbon in accordance with the reaction, CH₄→C+2H₂, which is an endothermic reaction with ΔH°=75 kJ/mole. The H₂ is generated as the carbon forms on the nanoparticle surfaces to form a solid carbon material such as carbon fiber. Thus, each kilogram of methane can produce 0.25 kg of H₂ and 0.75 kg of high-value solid carbon. The nanoparticles with attached carbon fibers can be carried downstream along with the H₂ until the carbon fibers reach an upper size limit and drop out of the stream. The carbon fibers can then be collected and further processed for use in a wide array of applications.

The H₂ produced by the reaction can then be supplied as fuel to a solid oxide fuel cell which can produce electricity at an efficiency of about 60-70%. The overall reaction in the solid oxide fuel cell, 2H₂+O₂→2H₂O, is an exothermic reaction, and the solid oxide fuel cell can thus operate at high temperatures (e.g., about 800° C.). A portion of the waste heat (e.g., 20%) from the solid oxide fuel cell can then be transferred back to the reactor to facilitate the further conversion of methane into H₂ and carbon fiber. By recycling the waste heat, an overall plant efficiency of 46% or higher can be attained. Moreover, upon reaching steady state conditions, no external heat source may be required.

Accordingly, embodiments provide for the generation of electricity with substantially no CO₂ emissions, a high plant efficiency of 46% or higher, and extremely low cost high-value solid carbon materials that can be used in a number of different applications.

### II. Definitions

“Reactor” refers to a vessel configured to contain a chemical reaction. Reactors useful in the present invention include reactors suitable for containing a reaction that converts a hydrocarbon into H₂ and a carbon material. Such suitable reactors include, but are not limited to, catalytic cracking reactors in the form of tank reactors, pipe reactors, tube reactors, batch reactors, and plug flow reactors.

“Hydrocarbon” refers to an organic compound consisting essentially of hydrogen and carbon. Hydrocarbons useful in the present invention include, but are not limited to, alkanes such as methane, ethane, propane, butane, octane, and dodecane, aromatics such as naphtha, kerosene, and diesel, and other suitable gaseous or liquid hydrocarbons.

“Catalyst” refers to a component that changes the rate of a chemical reaction but is not itself consumed in the chemical reaction. Catalysts useful in the present invention include, but are not limited to, metals such as alkali metals, alkali earth metals, transition metals, and post-transition metals, and metallic compounds including two or more metals (e.g., alloys). Alkali metals include Li, Na, K, Rb and Cs. Alkaline earth metals include Be, Mg, Ca, Sr and Ba. Transition metals include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, Tl, Ge, Sn, Pb, Sb, Bi, and Po.

“Carbon material” refers to a material including one or more allotropes of carbon. Carbon materials useful in the present invention include, but are not limited to, carbon fibers, carbon black, carbon nanotubes, buckyballs, graphite flakes, graphene, and mesoporous microbeads.

“Fuel cell” refers to an apparatus that converts the chemical energy from hydrogen fuel into electricity through a chemical reaction with oxygen to form water. Fuel cells useful in the present invention include, but are not limited to, high-temperature fuel cells such as solid oxide fuel cells and molten carbonate fuel cells.

“Precursor” refers to a compound that participates in a chemical reaction that produces another compound. Precursors useful in the present invention include, but are not limited to, metal forming precursors such as metal nitrates, metallocenes, and metal carbonyls. For instance, suitable metal nitrates can include Fe(NO₃)₃, Ni(NO₃)₂, Mn(NO₃)₂, and Co(NO₃)₃, suitable metallocenes can include Fe(C₅H₅)₂, C₁₂H₁₂FeO, C₁₂H₁₄Fe, Ni(C₅H₅)₂, C₁₂H₁₂NiO, C₁₂H₁₄Ni, W(C₅H₅)₂, C₁₂H₁₂WO, C₁₂H₁₄W, Mo(C₅H₅)₂, C₁₂H₁₂MoO, C₁₂H₁₄Mo, Mn(C₅H₅)₂, C₁₂H₁₂MnO, C₁₂H₁₄Mn, Co(C₅H₅)₂, C₁₂H₁₂CoO, and C₁₂H₁₄Co, and suitable metal carbonyls can include Fe(CO)₅, Ni(CO)₄, W(CO)₆, Mo(CO)₆, Mn₂(CO)₁₀, and Co₂(CO)₈.

III. Methods of Converting a Hydrocarbon into H₂ Fuel and a Carbon Material Comprising Substantially No CO₂

The present invention provides a method of converting a hydrocarbon into H₂ and a carbon material comprising substantially no CO₂, whereby the H₂ is used by a fuel cell to generate electrical energy and the carbon material is collected. The method includes heating a hydrocarbon and a catalyst in a reactor to form H₂ and a carbon material comprising substantially no CO₂. A fuel cell is operated to generate electrical energy and heat using the H₂ formed in the reactor. The step of heating is repeated using the heat generated in the fuel cell.

The hydrocarbon can be any suitable organic compound suitable for conversion into H₂ and a carbon material. Suitable hydrocarbons include, but are not limited to alkanes such as methane, ethane, propane, butane, octane, and dodecane, aromatics such as naphtha, kerosene, and diesel, and other suitable gaseous or liquid hydrocarbons. In some embodiments, the hydrocarbon can be methane, ethane, propane, or butane. In some other embodiments, the hydrocarbon can be methane.

The catalyst can be any suitable component that increases the reaction rate for converting the hydrocarbon into the H₂ and carbon material. Suitable catalysts can include, but are not limited to, metals including alkali metals such as Li, Na, K, Rb and Cs, alkaline earth metals such as Be, Mg, Ca, Sr and Ba, transition metals such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac, and post-transition metals such as Al, Ga, In, Tl, Ge, Sn, Pb, Sb, Bi, and Po, and metallic compounds including two or more metals (e.g., alloys). In some embodiments, the catalyst can include a transition metal. In other embodiments, the catalyst can include Fe, Ni, W, Mo, Mn, or Co. In some other embodiments, the catalyst can include Fe.

In some embodiments, the catalyst can be formed in situ from a metal forming precursor that decomposes in the reactor. Suitable metal forming precursors include, but are not limited to, metal nitrates, metallocenes, and metal carbonyls. For instance, suitable metal nitrates can include Fe(NO₃)₃, Ni(NO₃)₂, Mn(NO₃)₂, and Co(NO₃)₃, suitable metallocenes can include Fe(C₅H₅)₂, C₁₂H₁₂FeO, C₁₂H₁₄Fe, Ni(C₅H₅)₂, C₁₂H₁₂NiO, C₁₂H₁₄Ni, W(C₅H₅)₂, C₁₂H₁₂WO, C₁₂H₁₄W, Mo(C₅H₅)₂, C₁₂H₁₂MoO, C₁₂H₁₄Mo, Mn(C₅H₅)₂, C₁₂H₁₂MnO, C₁₂H₁₄Mn, Co(C₅H₅)₂, C₁₂H₁₂CoO, and C₁₂H₁₄Co, and suitable metal carbonyls can include Fe(CO)₅, Ni(CO)₄, W(CO)₆, Mo(CO)₆, Mn₂(CO)₁₀, and Co₂(CO)₈. In some embodiments, where Fe is the desired catalyst, the metal forming precursor can be Fe(NO₃)₃, Fe(C₅H₅)₂, C₁₂H₁₂FeO, C₁₂H₁₄Fe, or Fe(CO)₅. In some embodiments, the precursor can be introduced into the reactor as a fine spray of aqueous solution, a gas, or a solid (e.g., a powder). In some other embodiments, the catalyst can be formed in situ by way of an evaporative condensation reaction in the reactor. In some other embodiments, the catalyst can instead be introduced into the reactor after preparation in a separate reactor by way of a precursor decomposition reaction, an evaporative condensation process, or other suitable mechanism.

In some embodiments, the catalyst can be in the form of metallic particles that provide nucleation sites for conversion of the hydrocarbon, such that H₂ gas is generated as the carbon material forms on the metallic particle surfaces. The particles can have any suitable size and shape. For instance, in some embodiments, the catalyst can be in the form of metallic nanoparticles having a size (i.e. at least one dimension) less than about 1 μm, 950 nm, 900 nm, 850 nm, 750 nm, 650 nm, 550 nm, 450 nm, 350 nm, 250 nm, 150 nm, or less than about 100 nm.

In some embodiments, metallic nanoparticle catalysts can be formed in situ by way of the precursor decomposition reactions described herein. In some other embodiments, metallic nanoparticles can be formed by way of an evaporative condensation process. Such a process can involve homogenous nucleation of a metal in the gas phase followed by condensation and coagulation. To form the gas phase, in some embodiments, a high-current spark between two solid electrodes can be used to evaporate the electrode material, thereby forming a plasma at the electrodes. A continuous flow of inert gas (e.g., Ar) can transport metallic crystallites for collection and subsequent reaction with the hydrocarbon in the reactor. In some other embodiments, a metallic source can be heated by a furnace, laser, or flame to form the metallic gas phase which can then be cooled naturally, by dilution cooling, by mixture with a lower temperature gas, or by any other suitable cooling mechanism to form the metallic nanoparticles from the gas phase.

The carbon material formed in the reactor can include substantially no CO₂. In some embodiments, the carbon material can instead include one or more allotropes of solid carbon. For instance, the carbon material can comprise a material including carbon fibers, carbon black, carbon nanotubes, buckyballs, graphite flakes, graphene, or mesoporous microbeads. The morphology, size, type, and rate of formation of the carbon material can be affected by a number of different factors known in the art including, but not limited to, the type and particle size of the selected catalyst, and “residence time,” i.e. the length of time a catalyst particle is present within the reactor. In some embodiments, catalyst size can be affected by the precursor solution concentration, decomposition temperature, and the rate at which the precursor is “sprayed” or otherwise introduced into the reactor. Residence time can depend on particle size, pressure, flow rate, and other factors, and can be any suitable interval of time. Suitable residence times include, but are not limited to, about 5 to 90 seconds, 10 to 85 seconds, 15 to 80 seconds, 20 to 75 seconds, or about 25 to 70 seconds. In some embodiments, the residence time can be at about 30 to 60 seconds. In some other embodiments, the residence time can be less than about 5 seconds or greater than about 90 seconds.

The reactor can be any suitable reactor type known in the art that is suitable for heating a hydrocarbon and a catalyst such that a reaction that converts the hydrocarbon into H₂ and a carbon material is contained. Suitable reactors include, but are not limited to, catalytic cracking reactors in the form of tank reactors, pipe reactors, tube reactors, batch reactors, and plug flow reactors.

The hydrocarbon and catalyst can be heated to a temperature sufficient to form the H₂ and carbon material. For instance, in some embodiments, the hydrocarbon and catalyst can be heated in the reactor to a temperature from about 500 to 900° C., 525 to 850° C., 550 to 800° C., 575 to 750° C., 600 to 700° C., or from about 625 to 675° C. In some embodiments, the hydrocarbon and catalyst can be heated to a temperature of about 650° C. In some other embodiments, the hydrocarbon and catalyst can be heated to a temperature less than about 500° C., or heated to a temperature greater than about 900° C.

The carbon material generated in the reactor can be collected using any suitable method. In some embodiments, when the carbon material (e.g., fibers, particles, etc.) reaches an upper size limit, gravity may cause the material to “drop out” of the hydrocarbon flow stream. In some embodiments, a cyclone separation process can be utilized to separate the generated carbon material from the hydrocarbon in the reactor. In some other embodiments, the carbon material can be collected by “scraping” the material from interior walls of the reactor, or by utilizing an inert gas (e.g., N₂) introduced into the reactor at a high velocity to flush out the carbon material.

Upon collection, the carbon material can be used in any suitable application. Depending on the type of carbon material formed, suitable applications can include, but are not limited to, composite materials, microelectrodes, transistors, conductors, electrodes, capacitors, integrated circuits, photovoltaics, dry lubricants, desalination, medical applications, and many other applications. In some embodiments, the collected carbon material can be further processed to achieve the desired properties for particular applications.

In some embodiments, a portion of the hydrocarbon may not be converted into the H₂ and carbon material, and the unconverted portion of the hydrocarbon can be reintroduced into the reactor. Higher reactor temperatures can result in a larger fraction of the hydrocarbon being converted into H₂ and carbon material. In embodiments that rely on lower reactor temperatures, the hydrocarbon utilization fraction can be increased by recycling all or a portion of the unconverted hydrocarbon.

As described above, the H₂ generated in the reactor can be used by a fuel cell to generate electrical energy and heat. The H₂ can be transported from the reactor to the fuel cell using any suitable transport mechanism known in the art such as via a pipe, tube, hose, or other suitable mechanism.

The fuel cell can be any apparatus suitable for converting the H₂ formed in the reactor into electrical energy and heat. In some embodiments, the fuel cell can be a solid oxide fuel cell. The solid oxide fuel cell can utilize any suitable ceramic electrolyte known in the art including, but not limited to, yttria-stabilized zirconia (YSZ), scandia-stabilized zirconia (ScSZ), and gadolinium-doped ceria (GDC). The solid oxide fuel cell can operate at any suitable temperature including, but not limited to, from about 700 to 1000° C., 725 to 950° C., 750 to 900° C., or from about 775 to 850° C. In some embodiments, the solid oxide fuel cell can operate at a temperature of about 800° C. In some other embodiments, the solid oxide fuel cell can operate at a temperature less than about 700° C., or at a temperature greater than about 1000° C.

At least a portion of the heat generated by the fuel cell can be transferred back to the reactor to facilitate further formation of H₂ and carbon material. The heat can be transferred using any suitable conductive and/or convective mechanism. For instance, in some embodiments, a heat exchanger can utilize the exhaust steam from the solid oxide fuel cell to heat the reactor to a temperature sufficient to further convert hydrocarbon into H₂ and carbon material. Any suitable heat exchanger known in the art can be utilized, including, but not limited to, double pipe heat exchangers, shell and tube heat exchangers, plate heat exchangers, plate and shell heat exchangers, adiabatic wheel heat exchangers, plate fin heat exchangers, pillow plate heat exchangers, fluid heat exchangers, waste heat recovery units, dynamic scraped surface heat exchangers, phase-change heat exchangers, direct contact heat exchangers, and spiral heat exchangers.

In some embodiments, the reactor and fuel cell can be incorporated into a single device. For instance, the fuel cell and reactor can be arranged coaxially such that the fuel cell comprises an inner compartment (e.g., an inner cylinder), with the reactor comprising an outer compartment (e.g., an outer cylinder). In such embodiments, one or more walls separating the fuel cell and the reactor can have high thermal conductivity to allow heat generated by the fuel cell to directly heat a gaseous hydrocarbon stream present in the reactor.

In some embodiments, the method can include heating the hydrocarbon and the catalyst in the reactor to form the H₂ and carbon material comprising substantially no CO₂, wherein the hydrocarbon is methane, wherein the catalyst is formed in situ from a metal forming precursor including Fe(NO₃)₃, Fe(C₅H₅)₂, C₁₂H₁₂FeO, C₁₂H₁₄Fe, or Fe(CO)₅, wherein the catalyst includes Fe, and wherein the carbon material includes carbon fibers, carbon black, carbon nanotubes, buckyballs, graphite flakes, graphene, or mesoporous microbeads. The fuel cell can be operated to generate the electrical energy and heat using the H₂ formed in the reactor, wherein the fuel cell is a solid oxide fuel cell. The step of heating is repeated using the heat generated in the solid oxide fuel cell.

IV. Systems for Converting a Hydrocarbon into H₂ Fuel and a Carbon Material Comprising Substantially No CO₂

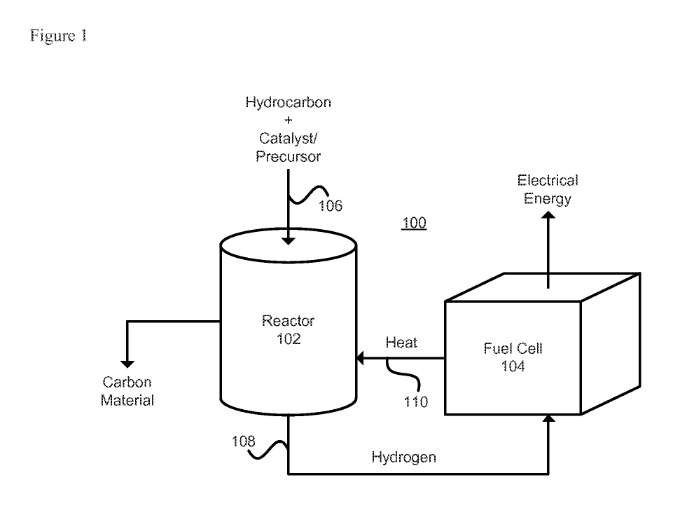

As shown in FIG. 1, the present invention also provides a system 100 for converting a hydrocarbon into H₂ and a carbon material comprising substantially no CO₂, whereby the H₂ is used by a fuel cell to generate electrical energy and the carbon material is collected. The system 100 includes a reactor 102 configured to heat a hydrocarbon and a catalyst to form H₂ and a carbon material comprising substantially no CO₂. The system further includes a fuel cell 104 configured to generate electrical energy and heat using the H₂ formed by the reactor, and to transfer the generated heat to the reactor 102.

The reactor 102 can be any suitable reactor type known in the art that is suitable for heating a hydrocarbon and a catalyst such that a reaction that converts the hydrocarbon into H₂ and a carbon material is contained. Suitable reactors include, but are not limited to, catalytic cracking reactors in the form of tank reactors, pipe reactors, tube reactors, batch reactors, and plug flow reactors. As shown in FIG. 1, the reactor 102 can include a hydrocarbon inlet 106 at which the hydrocarbon is introduced into the reactor 102. In some embodiments, the catalyst can also be introduced into the reactor 102 along with the hydrocarbon at inlet 106, or can be introduced via a separate inlet (not shown) of the reactor 102. As described in further detail below, in some embodiments, a precursor can be introduced into the reactor that decomposes into the catalyst in situ. In such embodiments, the precursor can be introduced along with the hydrocarbon at inlet 106, or can be introduced via a separate inlet (not shown) of the reactor 102.

The hydrocarbon and catalyst can be heated in the reactor 102 to a temperature sufficient to form the H₂ and carbon material. For instance, in some embodiments, the hydrocarbon and catalyst can be heated to a temperature from about 500 to 900° C., 525 to 850° C., 550 to 800° C., 575 to 750° C., 600 to 700° C., or from about 625 to 675° C. In some embodiments, the hydrocarbon and catalyst can be heated to a temperature of about 650° C. In some other embodiments, the hydrocarbon and catalyst can be heated to a temperature less than about 500° C., or heated to a temperature greater than about 900° C.

The hydrocarbon can be any suitable organic compound suitable for conversion into H₂ and a carbon material. Suitable hydrocarbons include, but are not limited to alkanes such as methane, ethane, propane, butane, octane, and dodecane, aromatics such as naphtha, kerosene, and diesel, and other suitable gaseous or liquid hydrocarbons. In some embodiments, the hydrocarbon can be methane, ethane, propane, or butane. In some other embodiments, the hydrocarbon can be methane.

The catalyst can be any suitable component that increases the reaction rate for converting the hydrocarbon into the H₂ and carbon material. Suitable catalysts include, but are not limited to, metals including alkali metals such as Li, Na, K, Rb and Cs, alkaline earth metals such as Be, Mg, Ca, Sr and Ba, transition metals such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac, and post-transition metals such as Al, Ga, In, Tl, Ge, Sn, Pb, Sb, Bi, and Po, and metallic compounds including two or more metals (e.g., alloys). In some embodiments, the catalyst can include a transition metal. In other embodiments, the catalyst can include Fe, Ni, W, Mo, Mn, or Co. In some other embodiments, the catalyst can include Fe.

In some embodiments, the catalyst can be introduced directly into the reactor 102. In other embodiments, the catalyst can be formed in situ from a metal forming precursor that decomposes in the reactor 102. Suitable metal forming precursors include, but are not limited to, metal nitrates, metallocenes, and metal carbonyls. For instance, suitable metal nitrates can include Fe(NO₃)₃, Ni(NO₃)₂, Mn(NO₃)₂, and Co(NO₃)₃, suitable metallocenes can include Fe(C₅H₅)₂, C₁₂H₁₂FeO, C₁₂H₁₄Fe, Ni(C₅H₅)₂, C₁₂H₁₂NiO, C₁₂H₁₄Ni, W(C₅H₅)₂, C₁₂H₁₂WO, C₁₂H₁₄W, Mo(C₅H₅)₂, C₁₂H₁₂MoO, C₁₂H₁₄Mo, Mn(C₅H₅)₂, C₁₂H₁₂MnO, C₁₂H₁₄Mn, Co(C₅H₅)₂, C₁₂H₁₂CoO, and C₁₂H₁₄Co, and suitable metal carbonyls can include Fe(CO)₅, Ni(CO)₄, W(CO)₆, Mo(CO)₆, Mn₂(CO)₁₀, and Co₂(CO)₈. In some embodiments, where Fe is the desired catalyst, the metal forming precursor can be Fe(NO₃)₃, Fe(C₅H₅)₂, C₁₂H₁₂FeO, C₁₂H₁₄Fe, or Fe(CO)₅. In some embodiments, the precursor can be introduced into the reactor 102 as a fine spray of aqueous solution, a gas, or a solid (e.g., a powder). In some other embodiments, the catalyst can be formed in situ by way of an evaporative condensation reaction in the reactor 102. In some other embodiments, the catalyst can instead be introduced into the reactor 102 after preparation in a separate reactor (not shown) by way of a precursor decomposition reaction, an evaporative condensation process, or other suitable mechanism.

In some embodiments, the catalyst can be in the form of metallic particles that provide nucleation sites for conversion of the hydrocarbon, such that H₂ gas is generated as the carbon material forms on the metallic particle surfaces. The particles can have any suitable size and shape. For instance, in some embodiments, the catalyst can be in the form of metallic nanoparticles having a size (i.e. at least one dimension) less than about 1 μm, 950 nm, 900 nm, 850 nm, 750 nm, 650 nm, 550 nm, 450 nm, 350 nm, 250 nm, 150 nm, or less than about 100 nm.

In some embodiments, metallic nanoparticle catalysts can be formed in situ by way of the precursor decomposition reactions described herein. In some other embodiments, metallic nanoparticles can be formed by way of an evaporative condensation process. Such a process can involve homogenous nucleation of a metal in the gas phase followed by condensation and coagulation. To form the gas phase, in some embodiments, a high-current spark between two solid electrodes can be used to evaporate the electrode material, thereby forming a plasma at the electrodes. A continuous flow of inert gas (e.g., Ar) can transport metallic crystallites for collection and subsequent reaction with the hydrocarbon in the reactor 102. In some other embodiments, a metallic source can be heated by a furnace, laser, or flame to form the metallic gas phase which can then be cooled naturally, by dilution cooling, by mixture with a lower temperature gas, or by any other suitable cooling mechanism to form the metallic nanoparticles from the gas phase.

The carbon material formed in the reactor 102 can include substantially no CO₂. In some embodiments, the carbon material can instead include one or more allotropes of solid carbon. For instance, the carbon material can comprises a material including carbon fibers, carbon black, carbon nanotubes, buckyballs, graphite flakes, graphene, or mesoporous microbeads. The morphology, size, type, and rate of formation of the carbon material can be affected by a number of different factors known in the art including, but not limited to, the type and particle size of the selected catalyst, and “residence time,” i.e. the length of time a catalyst particle is present within the reactor 102. In some embodiments, catalyst size can be affected by the precursor solution concentration, decomposition temperature, and the rate at which the precursor is “sprayed” or otherwise introduced into the reactor 102. Residence time can depend on particle size, pressure, flow rate, and other factors, and can be any suitable interval of time. Suitable residence times include, but are not limited to, about 5 to 90 seconds, 10 to 85 seconds, 15 to 80 seconds, 20 to 75 seconds, or about 25 to 70 seconds. In some embodiments, the residence time can be about 30 to 60 seconds. In some other embodiments, the residence time can be less than about 5 seconds or greater than about 90 seconds.

The carbon material generated in the reactor 102 can be collected using any suitable method, and can be used in any suitable application. In some embodiments, when the carbon material (e.g., fibers, particles, etc.) reach an upper size limit, gravity may cause the material to “drop out” of the hydrocarbon flow stream. In some embodiments, a cyclone separation process can be utilized to separate the generated carbon material from the hydrocarbon in the reactor 102. In some other embodiments, the carbon material can be collected by “scraping” the material from interior walls of the reactor 102, or by utilizing an inert gas (e.g., N₂) introduced into the reactor 102 at a high velocity to flush out the carbon material.

Upon collection, the carbon material can be used in any suitable application. Depending on the type of carbon material formed, suitable applications can include, but are not limited to, composite materials, microelectrodes, transistors, conductors, electrodes, capacitors, integrated circuits, photovoltaics, dry lubricants, desalination, medical applications, and many other applications. In some embodiments, the collected carbon material can be further processed to achieve the desired properties for particular applications.

The fuel cell 104 can be any apparatus suitable for converting the H₂ formed in the reactor 102 into electrical energy and heat. In some embodiments, the fuel cell 104 can be a solid oxide fuel cell. The solid oxide fuel cell 104 can utilize any suitable ceramic electrolyte known in the art including, but not limited to, yttria-stabilized zirconia (YSZ), scandia-stabilized zirconia (ScSZ), and gadolinium-doped ceria (GDC). The solid oxide fuel cell 104 can operate at any suitable temperature including, but not limited, from about 700 to 1000° C., 725 to 950° C., 750 to 900° C., or from about 775 to 850° C. In some embodiments, the solid oxide fuel cell 104 can operate at a temperature of about 800° C. In some other embodiments, the solid oxide fuel cell 104 can operate at a temperature less than about 700° C., or at a temperature greater than about 1000° C.

A portion of the hydrocarbon may not be converted into the H₂ and the carbon material. In some embodiments, the unconverted portion of the hydrocarbon can be reintroduced into the reactor 102. For instance, a splitter can be utilized at a hydrocarbon outlet (not shown) such that all or a portion of the unconverted hydrocarbon can be injected back into the reactor 102, such as at the hydrocarbon inlet 106. Higher reactor temperatures can result in a larger fraction of the hydrocarbon being converted into H₂ and carbon material. In embodiments that rely on lower reactor temperatures, the hydrocarbon utilization fraction can be increased by recycling all or a portion of the unconverted hydrocarbon.

The H₂ generated in the reactor 102 can be used by the fuel cell 104 to generate electrical energy and heat. The H₂ can be transported from the reactor 102 to the fuel cell 104 by way of a hydrogen transport element 108 which can be any suitable component known in the art that is capable of transporting H₂ such as a pipe, tube, hose, or other suitable component.

At least a portion of the heat generated by the fuel cell 104 can be transferred back to the reactor 102 to facilitate further formation of H₂ and carbon material. The heat can be transferred using a heat transfer element 110 which can be any component configured to transport heat by way of conduction and/or convection. For instance, in some embodiments, the heat transfer element 110 can be a heat exchanger that utilizes the exhaust steam from the fuel cell 104 to heat the reactor 102 to a temperature sufficient to further convert hydrocarbon into H₂ and carbon material. Heat transfer element 110 can be any suitable heat exchanger known in the art. Such suitable heat exchangers include, but are not limited to, double pipe heat exchangers, shell and tube heat exchangers, plate heat exchangers, plate and shell heat exchangers, adiabatic wheel heat exchangers, plate fin heat exchangers, pillow plate heat exchangers, fluid heat exchangers, waste heat recovery units, dynamic scraped surface heat exchangers, phase-change heat exchangers, direct contact heat exchangers, and spiral heat exchangers.

In some embodiments, the reactor 102 and fuel cell 104 can be incorporated into a single device. For instance, the fuel cell 104 and reactor 102 can be arranged coaxially such that the fuel cell 104 comprises an inner compartment (e.g., an inner cylinder), with the reactor 102 comprising an outer compartment (e.g., an outer cylinder). In such embodiments, one or more walls separating the fuel cell 104 and the reactor 102 can have high thermal conductivity to allow heat generated by the fuel cell 104 to directly heat a gaseous hydrocarbon stream present in the reactor 102.

In some embodiments, the system 100 can demonstrate an overall energy efficiency from about 25 to 46%. In some embodiments, the system 100 can demonstrate an overall efficiency of about 46% and, in some embodiments, the system of 100 can demonstrate an overall efficiency greater than about 46%.

In some embodiments, the system 100 can include the reactor 102 configured to heat the hydrocarbon and catalyst to form the H₂ and carbon material comprising substantially no CO₂, wherein the hydrocarbon is methane, wherein the reactor 102 is further configured to form the catalyst in situ from a metal forming precursor including Fe(NO₃)₃, Fe(C₅H₅)₂, C₁₂H₁₂FeO, C₁₂H₁₄Fe, or Fe(CO)₅, wherein the catalyst comprises Fe, and wherein the carbon material comprises a material including carbon fibers, carbon black, carbon nanotubes, buckyballs, graphite flakes, graphene, or mesoporous microbeads. The system 100 can further include the fuel cell 104 configured to generate the electrical energy and heat using the H₂ formed by the reactor 102 and to transfer the generated heat to the reactor 102, wherein the fuel cell 104 is a solid oxide fuel cell, and wherein the system 100 demonstrates an overall energy efficiency from about 25 to 46%.

### EXAMPLE

### Example 1

### Converting Methane Into H₂ Fuel and Carbon Fiber

This example provides a method according to the present invention of converting methane into H₂ and carbon fiber in a reactor using the system 100 illustrated in FIG. 1, whereby the H₂ is used by a solid oxide fuel cell 104 to generate electrical energy and heat, the heat being usable by the reactor 102 to further generate methane and H₂ fuel.

Methane gas is introduced into the reactor 102 along with iron nitrate, Fe(NO₃)₃, as a metal forming precursor. The iron nitrate is introduced into the reactor 102 as a fine mist of aqueous solution. The methane/iron nitrate mixture is initially heated in the reactor 102 to a temperature of about 650° C. using an external heating source that generates heat by way of a methane combustion reaction. The heating causes the iron nitrate to decompose into Fe nanoparticles which act as catalysts for the methane conversion reaction. H₂ gas is generated as the carbon forms on the Fe nanoparticle surfaces in the form of carbon fibers. The Fe nanoparticles with attached carbon fibers are carried downstream with the H₂ gas in the reactor 102 until the carbon fibers reach an upper size limit and drop out of the stream. The carbon fibers are subsequently collected for further processing.

The H₂ gas produced in the reactor 102 is then supplied via a pipe 108 to the solid oxide fuel cell 104 which generates electricity using the H₂ at an efficiency of about 60-70% and at an operating temperature of about 800° C. A heat exchanger 110 transfers about 20% of the heat from the exhaust steam of the solid oxide fuel cell 104 to the reactor 102, thereby maintaining the reactor temperature at 650° C. and facilitating the further generation of H₂ gas and carbon fiber in the reactor 102. By recycling the waste heat from the solid oxide fuel cell 104, an overall plant efficiency of about 46% is attained.

A steady state is reached where methane and iron nitrate are continuously introduced into the reactor 102, H₂ gas is continuously supplied from the reactor 102 to the solid oxide fuel cell 104 for electricity generation, and waste heat is continuously transferred from the solid oxide fuel cell 104 to the reactor 102. When the steady state conditions are attained, no external heat source is required for the system 100 to continue generating electricity and carbon fiber.

Although the foregoing invention has been described in some detail by way of illustration and example for purposes of clarity of understanding, one of skill in the art will appreciate that certain changes and modifications can be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method of converting a hydrocarbon into H₂ and a carbon material comprising substantially no CO₂, whereby the H₂ is used by a fuel cell to generate electrical energy and the carbon material is collected, the method comprising:
heating a hydrocarbon and a catalyst in a reactor to form H₂ and a carbon material comprising substantially no CO_{2;}
operating a fuel cell to generate electrical energy and heat using the H₂ formed in the reactor; and
repeating the step of heating using the heat generated in the fuel cell.

2. The method of claim 1, wherein the hydrocarbon is selected from the group consisting of methane, ethane, propane, and butane.

3. The method of claim 1, wherein the hydrocarbon is methane

4. The method of claim 1, wherein the catalyst comprises Fe.

5. The method of claim 1, wherein the catalyst is formed in situ from a metal forming precursor selected from the group consisting of metal nitrates, metallocenes, and metal carbonyls.

6. The method of claim 1, wherein the catalyst is formed in situ from a metal forming precursor selected from the group consisting of Fe(NO₃)₃, Fe(C₅H₅)₂, C₁₂H₁₂FeO, C₁₂H₁₄Fe, and Fe(CO)₅.

7. The method of claim 1, wherein the carbon material comprises a material selected from the group consisting of carbon fibers, carbon black, carbon nanotubes, buckyballs, graphite flakes, graphene, and mesoporous microbeads.

8. The method of claim 1, wherein the fuel cell is a solid oxide fuel cell.

9. The method of claim 1, wherein a portion of the hydrocarbon is not converted into the H₂ and carbon material, and wherein the method further comprises reintroducing the unconverted portion of the hydrocarbon into the reactor.

10. The method of claim 1, wherein the method comprises:
heating the hydrocarbon and the catalyst in the reactor to form the H₂ and carbon material comprising substantially no CO₂, wherein the hydrocarbon is methane, wherein the catalyst is formed in situ from a metal forming precursor selected from the group consisting of Fe(NO₃)₃, Fe(C₅H₅)₂, C₁₂H₁₂FeO, C₁₂H₁₄Fe, and Fe(CO)₅, wherein the catalyst comprises Fe, and wherein the carbon material comprises a material selected from the group consisting of carbon fibers, carbon black, carbon nanotubes, buckyballs, graphite flakes, graphene, and mesoporous microbeads;
operating the fuel cell to generate the electrical energy and heat using the H₂ formed in the reactor, wherein the fuel cell is a solid oxide fuel cell; and
repeating the step of heating using the heat generated in the solid oxide fuel cell.

11. A system for converting a hydrocarbon into H₂ and a carbon material comprising substantially no CO₂, whereby the H₂ is used by a fuel cell to generate electrical energy and the carbon material is collected, the system comprising:
a reactor configured to:
heat a hydrocarbon and a catalyst to form H₂ and a carbon material comprising substantially no CO₂; and
a fuel cell configured to:
generate electrical energy and heat using the H₂ formed by the reactor; and
transfer the generated heat to the reactor.

12. The system of claim 11, wherein the hydrocarbon is selected from the group consisting of methane, ethane, propane, and butane.

13. The system of claim 11, wherein the hydrocarbon is methane.

14. The system of claim 11, wherein the catalyst comprises Fe.

15. The system of claim 11, wherein the reactor is further configured to form the catalyst in situ from a metal forming precursor selected from the group consisting of metal nitrates, metallocenes, and metal carbonyls.

16. The system of claim 11, wherein the reactor is further configured to form the catalyst in situ from a metal forming precursor selected from the group consisting of Fe(NO₃)₃, Fe(C₅H₅)₂, C₁₂H₁₂FeO, C₁₂H₁₄Fe, and Fe(CO)₅.

17. The system of claim 11, wherein the carbon material comprises a material selected from the group consisting of carbon fibers, carbon black, carbon nanotubes, buckyballs, graphite flakes, graphene, and mesoporous microbeads.

18. The system of claim 11, wherein the fuel cell is a solid oxide fuel cell.

19. The system of claim 11, wherein the system demonstrates an overall energy efficiency from about 25 to 46%.

20. The system of claim 11, wherein the system comprises:
the reactor configured to:
heat the hydrocarbon and catalyst to form the H₂ and carbon material comprising substantially no CO₂, wherein the hydrocarbon is methane, wherein the reactor is further configured to form the catalyst in situ from a metal forming precursor selected from the group consisting of Fe(NO₃)₃, Fe(C₅H₅)₂, C₁₂H₁₂FeO, C₁₂H₁₄Fe, and Fe(CO)₅, wherein the catalyst comprises Fe, and wherein the carbon material comprises a material selected from the group consisting of carbon fibers, carbon black, carbon nanotubes, buckyballs, graphite flakes, graphene, and mesoporous microbeads; and
the fuel cell configured to:
generate the electrical energy and heat using the H₂ formed by the reactor; and
transfer the generated heat to the reactor, wherein the fuel cell is a solid oxide fuel cell, and wherein the system demonstrates an overall energy efficiency from about 25 to 46%.
